(19) United States
(12) Patent Application Publication
(10) Pub. No.: US 2025/0265514 A1
(43) Pub. Date: Aug. 21, 2025

(54) METHOD

(71) Applicant: TOYOTA JIDOSHA KABUSHIKI KAISHA, Toyota-shi Aichi-ken (JP)

(72) Inventors: Koji UEDA, Funabashi-shi Chiba-ken (JP); Ibuki SHIMADA, Miyoshi-shi Aichi-ken (JP); Kazuhiro UMEDA, Mitaka-shi Tokyo-to (JP); Katsuhiro WATANABE, Kawasaki-shi Kanagawa-ken (JP)

(73) Assignee: TOYOTA JIDOSHA KABUSHIKI KAISHA, Toyota-shi Aichi-ken (JP)

(21) Appl. No.: 19/055,826

(22) Filed: Feb. 18, 2025

(30) Foreign Application Priority Data
Feb. 19, 2024 (JP) 2024-023229

(51) Int. Cl. G06Q 10/0631; G06Q 50/47

(52) U.S. Cl. CPC G06Q 10/06311; G06Q 50/47

(57) ABSTRACT

An information processing apparatus used for providing an operation management system that manages operations of a plurality of vehicles acquires information on an extra service based on a GTFS file containing information on the extra service to be additionally registered in the operation management system or based on information on an operating service that has been registered in the operation management system. The information processing apparatus then creates an operation schedule for the extra service based on the information on the extra service.

### CROSS-REFERENCE TO RELATED APPLICATION

This application claims priority to Japanese Patent Application No. 2024-0233229 filed on Feb. 19, 2024, the entire contents of which are incorporated herein by reference.

### TECHNICAL FIELD

The present disclosure relates to a method.

### BACKGROUND

Operation management systems that manage operation plans for vehicles are known. For example, Patent Literature (PTL) 1 discloses an operation management system for multiple transportation operators.

### CITATION LIST

### Patent Literature

PTL 1: JP 2020-155095 A

### SUMMARY

There is room for improvement with respect to technology of operation management systems that manage operation plans for vehicles.

It would be helpful to improve technology of operation management systems that manage operation plans for vehicles.

A method according to an embodiment of the present disclosure is a method performed by an information processing apparatus used for providing an operation management system that manages operations of a plurality of vehicles, the method including:
acquiring information on an extra service based on a GTFS file containing information on the extra service to be additionally registered in the operation management system or based on information on an operating service that has been registered in the operation management system; and
creating an operation schedule for the extra service based on the information on the extra service.

According to an embodiment of the present disclosure, technology of operation management systems that manage operation plans for vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of a vehicle;

FIG. 4 is a block diagram illustrating a schematic configuration of an information processing apparatus; and

FIG. 5 is a flowchart illustrating operations of the information processing apparatus.

### DETAILED DESCRIPTION

Hereinafter, an embodiment of the present disclosure will be described.

### Outline of Embodiment

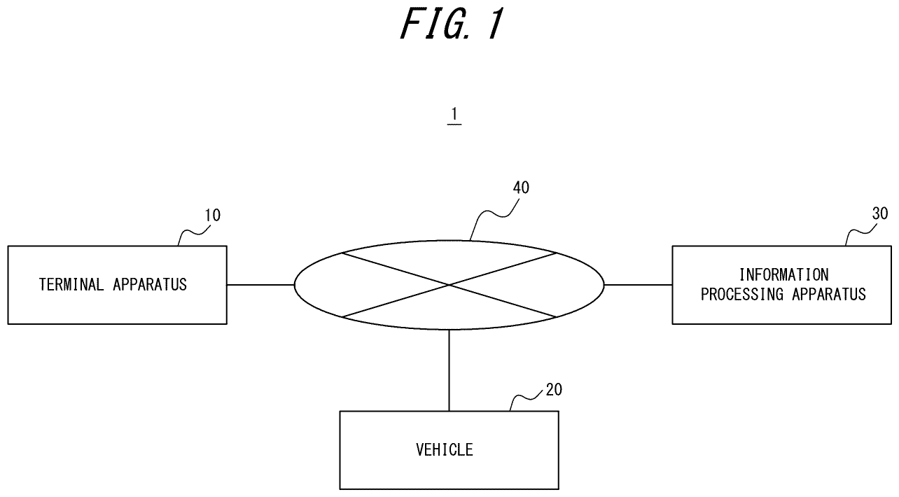

An outline of a system 1 according to the embodiment of the present disclosure will be described with reference to FIG. 1. The system 1 includes a plurality of terminal apparatuses 10, a plurality of vehicles 20, and an information processing apparatus 30. The terminal apparatuses 10, the vehicles 20, and the information processing apparatus 30 are communicably connected to a network 40 including, for example, the Internet, a mobile communication network, and the like.

The terminal apparatuses 10 are computers, such as personal computers (PCs), smartphones, or tablet terminals. In the present embodiment, the terminal apparatuses 10 are used by users who manage operations of vehicles 20, and are connected to the information processing apparatus 30 via the network 40 to input and output information necessary to manage the operations of the vehicles 20. In an example, a user can use the terminal apparatus 10 to log into the operation management system of a local bus service and create an operation schedule for an operating service by assigning the vehicle 20 to the information on the operating service that has been registered in the operation management system.

The vehicles 20 are, for example, gasoline automobiles, battery electric vehicles (BEVs), hybrid electric vehicles (HEVs), plug-in hybrid electric vehicles (PHEVs), fuel cell electric vehicles (FCEVs), or the like, but not limited to these and may be any vehicle that people can board. In the present embodiment, the vehicles 20 can communicate with the information processing apparatus 30 via the network 40. In an example, the vehicles 20 are used as route buses.

The information processing apparatus 30 is one computer or a plurality of computers, e.g., server apparatuses, that can communicate with each other. The information processing apparatus 30 can communicate with each terminal apparatus 10 and each vehicle 20 via the network 40. In an example, the information processing apparatus 30 is used to provide an operation management system that manages the operation of the plurality of vehicles 20 in a route bus service.

First, an outline of the present embodiment will be described, and details thereof will be described later. The information processing apparatus 30 used for providing an operation management system that manages operations of the plurality of vehicles 20 acquires information on an extra service based on a GTFS file containing the information on the extra service to be additionally registered in the operation management system or based on information on an operating service that has been registered in the operation management system. The information processing apparatus 30 then creates an operation schedule for the extra service based on the information on the extra service.

In an operation management system that uses GTFS files, information on scheduled services in the GTFS files can be captured by registering the GTFS files in the operation management system. However, in addition to services that operate on a fixed schedule and route (hereinafter referred to as “scheduled fixed route services”), extra services may be operated on short notice. In such cases, registering extra services with the GTFS file used for scheduled fixed route services can be a complicated process for the user. In contrast, according to the present embodiment, information on extra services can be acquired based on a GTFS file containing only information on extra services to be additionally registered in the operation management system or based on information on operating services that have been registered in the operation management system. This simplifies the user's work and reduces the probability of work errors. Therefore, according to the present embodiment, the user's work when creating an operation schedule for an extra service is simplified compared to the conventional technology, and technology of operation management systems that manage operation plans for vehicles is improved in that the probability of work errors occurring can be reduced.

Next, configurations of the system I will be described in detail.

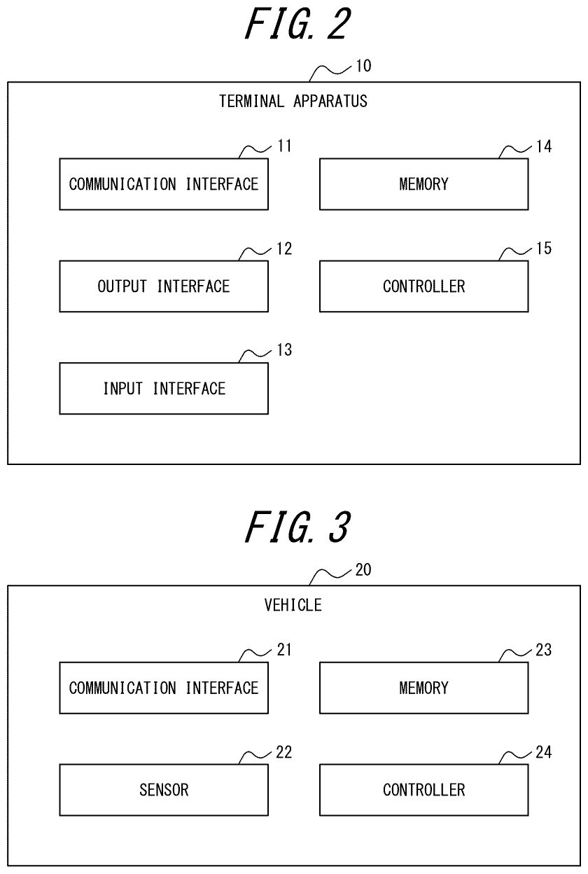

As illustrated in FIG. 2, each terminal apparatus 10 includes a communication interface 11, an output interface 12, an input interface 13, a memory 14, and a controller 15.

The communication interface 11 includes at least one communication interface for connecting to the network 40. The communication interface is compliant with a mobile communication standard such as the 4th generation (4G) standard or the 5th generation (5G) standard, for example, but is not limited to these. In the present embodiment, the terminal apparatus 10 communicates with the information processing apparatus 30 via the communication interface 11 and the network 40.

The output interface 12 includes at least one output device for outputting information. The output device is, for example, a display for outputting information as video, a speaker for outputting information as audio, or the like, but is not limited to these. Alternatively, the output interface 12 may include an interface for connecting to an external output device.

The input interface 13 includes at least one input device for detecting an input operation by a user. The input device is, for example, a physical key, a capacitive key, a mouse, a touch panel, a touch screen integrally provided with a display of the output interface 12, a microphone, or the like, but is not limited to these. Alternatively, the input interface 13 may include an interface for connecting to an external input device.

The memory 14 includes one or more memories. The memories are, for example, semiconductor memories, magnetic memories, optical memories, or the like, but are not limited to these. The memories included in the memory 14 may each function as, for example, a main memory, an auxiliary memory, or a cache memory. The memory 14 stores any information to be used for operations of the terminal apparatus 10. The memory 14 may store driving record information acquired from the vehicles 20. For example, the memory 14 may store a system program, an application program, embedded software, or the like. The information stored in the memory 14 may be updated with, for example, information acquired from the network 40 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the entire terminal apparatus 10.

### Configuration of Vehicle

As illustrated in FIG. 3, each vehicle 20 includes a communication interface 21, a sensor 22, a memory 23, and a controller 24.

The communication interface 21 includes at least one communication interface for connecting to the network 40. The communication interface is compliant with mobile communication standards such as the 4th generation (4G) standard and the 5th generation (5G) standard, for example, but not limited to these, and may be compliant with any communication standard. In the present embodiment, the vehicle 20 communicates with the information processing apparatus 30 via the communication interface 21 and the network 40.

The sensor 22 includes one or more sensors for use in control of the vehicle 20. The sensors include, for example, a position sensor corresponding to a global positioning system (GPS) or the like, a geomagnetic sensor, a velocity sensor, an acceleration sensor, a gyro sensor, or the like, but are not limited to these and may include any sensor.

The memory 23 includes one or more memories. In the present embodiment, the “memories” are semiconductor memories, magnetic memories, optical memories, or the like, for example, but are not limited to these. The memories included in the memory 23 may each function as, for example, a main memory, an auxiliary memory, or a cache memory. The memory 23 stores any information to be used for operations of the vehicle 20. For example, the memory 23 may store a system program, an application program, embedded software, or the like. The information stored in the memory 23 may be updated with, for example, information acquired from the network 40 via the communication interface 21.

The controller 24 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 24 controls operations of the entire vehicle 20.

### Configuration of Information Processing Apparatus

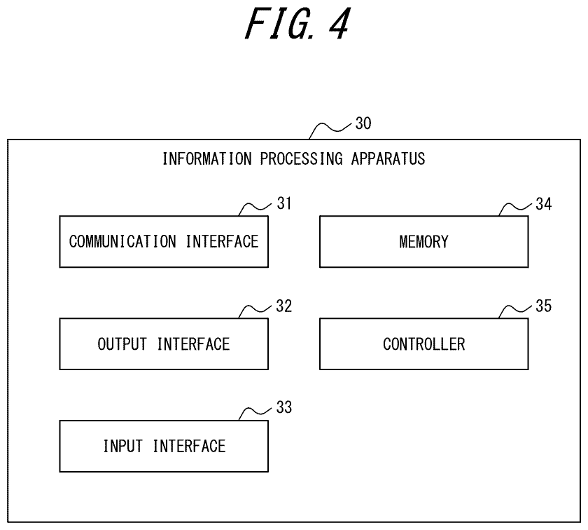

As illustrated in FIG. 4, the information processing apparatus 30 includes a communication interface 31, an output interface 32, an input interface 33, a memory 34, and a controller 35.

The communication interface 31 includes at least one communication interface for connecting to the network 40. The communication interface is compliant with a wired LAN standard or a wireless LAN standard, for example, but is not limited to these, and may be compliant with any communication standard. In the present embodiment, the information processing apparatus 30 communicates with the terminal apparatuses 10 and the vehicles 20 via the communication interface 31 and the network 40.

The output interface 32 includes at least one output device for outputting information. The output device is, for example, a display for outputting information as video, a speaker for outputting information as audio, or the like, but is not limited to these. Alternatively, the output interface 32 may include an interface for connecting to an external output device.

The input interface 33 includes at least one input device for detecting an input operation by a user. The input device is, for example, a physical key, a capacitive key, a mouse, a touch panel, a touch screen integrally provided with a display of the output interface 32, a microphone, or the like, but is not limited to these. Alternatively, the input interface 33 may include an interface for connecting to an external input device.

The memory 34 includes one or more memories. The memories included in the memory 34 may each function as, for example, a main memory, an auxiliary memory, or a cache memory. The memory 34 stores any information to be used for operations of the information processing apparatus 30. For example, the memory 34 may store a system program, an application program, embedded software, map information, and the like. In the present embodiment, the memory 34 stores information used to manage the operation of the vehicles 20, such as operation schedules, information on the vehicles 20, and the like.

The “operation schedule” is the information on the operating service plus the information on the vehicles assigned to the operating service. The “information on the operating service” includes information that uniquely identifies the route of the operating service, such as the route ID, information that uniquely identifies the operating service, such as the service ID described above, information on each transit point on the route of the operating service, and information on the corresponding time to pass each transit point, but may include information necessary for the operating service, not limited to the above. For example, the information on the operating service may include information on the operation date that identifies the operation date of the operating service.

The controller 35 includes at least one processor, at least one programmable circuit, at least one dedicated circuit, or a combination of these. The controller 35 controls operations of the entire information processing apparatus 30.

### Operation Flow of Information Processing Apparatus 30

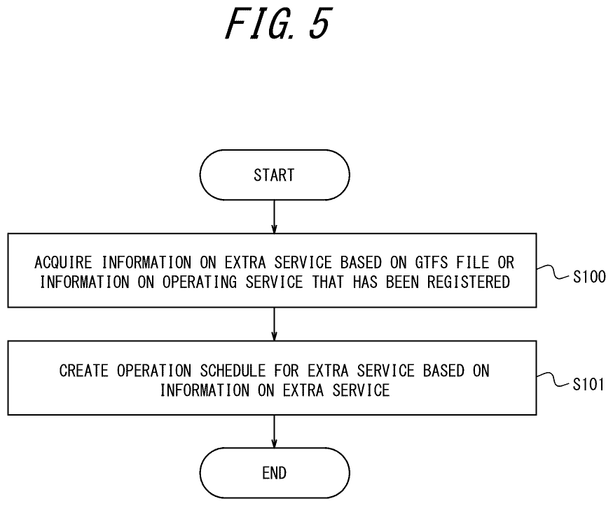

Operations of the information processing apparatus 30 according to the present embodiment will be described with reference to FIG. 5.

S100: The controller 35 of the information processing apparatus 30 acquires information on an extra service based on a GTFS file containing information on the extra service to be additionally registered in the operation management system or based on information on an operating service that has been registered in the operation management system.

Specifically, the user may enter a GTFS file with information on the extra service, for example, using a form displayed on the screen of the terminal apparatus 10 or the information processing apparatus 30. The controller 35 may then retrieve the information contained in the input GTFS file as the information on the extra service. Hereinafter, the acquisition of information on extra services using GTFS files is also referred to as an “extra service intake”. Alternatively, the user may select, for example, from among the multiple operating services or schedules already registered in the operation management system that are displayed on the screen of the terminal apparatus 10 or the information processing apparatus 30, the operating service or the operation schedule that the user wishes to use as the basis for the information on the additional extra service to be registered. The controller 35 then acquires the information on the selected operating service or operation schedule as the information on the extra service, except for a part of the information on the selected operating service or operation schedule (e.g., information uniquely identifying the service, such as a service ID, and the information on the assigned vehicle 20). The acquisition of information on the selected operating service or extra service based on the operation schedule is hereinafter also referred to as “operation duplication”. Here, the controller 35 may automatically assign the service ID of the extra service so that the user can distinguish the service ID of the extra service from the service ID of the scheduled fixed route service. For example, users can distinguish between scheduled fixed route services and extra services by using a different number of digits or numerical range for the service ID.

In the case of extra import, the user has to create a GTFS file, but if there are multiple extra services that need to be registered, for example, 10 services, the controller 35 can acquire information on multiple extra services at once. In the case of operation duplication, for example, a simple user selection operation, such as one click by the user on a single operating service to be duplicated, allows the controller 35 to acquire information on extra services. Thus, by providing the user with two methods for acquiring information on extra services, the user's task of creating an operation schedule for extra services can be made more efficient.

The “information on the operation date” may be expressed in terms of a specific month, date, or day of the week. The information on the operation date may also include information such as a flag to determine whether the service is repeated (scheduled fixed route service) or one-time (extra service), for example. In the case of operation duplication, information such as a discrimination flag, etc., which the controller 35 acquires as information on an extra service, may be information that can be determined as an extra service.

In the case of operation duplication, the controller 35 may or may not acquire the information on the operation date as part of the information on the extra service. The controller 35 may or may not acquire information on the corresponding time to pass each of the transit points as information on the extra services. The controller 35 may also provide an interface that allows the user to select whether the information on the operation date and the information on the corresponding time to pass each transit point are each information on the extra service. The interface may be provided in any form, such as a check box on a screen to select the operating service or operation schedule the user wishes to use as information for an extra service, or in any form on a separate screen, for example.

S101: The controller 35 creates an operation schedule for the extra service based on the information on the extra service.

Specifically, the controller 35 displays the information on the extra services acquired in S100 on the screen of the terminal apparatus 10 or the information processing apparatus 30 used by the user. The user then assigns the vehicle 20 to the information on the extra service displayed on the screen of the terminal apparatus 10 or the information processing apparatus 30. The controller 35 then adds the information on the vehicle 20 assigned by the user to the information on the extra service, creates an operation schedule for the extra service, and displays the information on the operation schedule for the extra service on the screen of the terminal apparatus 10 or the information processing apparatus 30.

The assignment of the vehicles 20 by the user may be made by any form, such as text boxes, check boxes, etc., on the screen where the information on the extra service is displayed, or by any form on a separate screen. The controller 35 may control the selection of the vehicles 20 to be assigned to the extra service from among the plurality of vehicles 20 excluding each vehicle 20 that has been assigned to any of the operating services registered in the operation management system. Specifically, the controller 35 may identify the vehicles 20 that are not assigned to another operation schedule that partially overlaps with the time period between the earliest and latest times of the respective times to pass the transit points on the route of the extra service, and when the user assigns a vehicle 20 to the extra service, only the identified vehicle 20 may be displayed on the screen where the vehicles 20 are assigned as the vehicles 20 that can be assigned.

The controller 35 may also initially display the information on one of the identified vehicles 20 as the vehicle assigned to the extra service on the screen on which the information on the extra service is displayed.

As described above, the information processing apparatus 30 used for providing an operation management system that manages operations of a plurality of vehicles acquires information on an extra service based on a GTFS file containing information on the extra service to be additionally registered in the operation management system or based on information on an operating service that has been registered in the operation management system. The information processing apparatus 30 then creates an operation schedule for the extra service based on the information on the extra service.

In an operation management system that uses GTFS files, information on scheduled services in the GTFS files can be captured by registering the GTFS files in the operation management system. However, in addition to services that operate on a fixed schedule and route (hereinafter referred to as “scheduled fixed route services”), extra services may be operated on short notice. In such cases, registering extra services with the GTFS file used for scheduled fixed route services can be a complicated process for the user. In contrast, according to the present embodiment, information on extra services can be acquired based on a GTFS file containing only information on extra services to be additionally registered in the operation management system or based on information on operating services that have been registered in the operation management system. This simplifies the user's work and reduces the probability of work errors. Therefore, according to the present embodiment, the user's work when creating an operation schedule for an extra service is simplified compared to the conventional technology, and technology of operation management systems that manage operation plans for vehicles is improved in that the probability of work errors occurring can be reduced.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or a single component, step, or the like can be divided.

For example, an embodiment in which the configuration and operations of the terminal apparatus 10 and/or the information processing apparatus 30 in the above embodiment are distributed to multiple computers capable of communicating with each other can be implemented. For example, an embodiment in which some or all of the components of the information processing apparatus 30 are provided in the terminal apparatus 10 is also possible, and vice versa, an embodiment in which some or all of the components of the terminal apparatus 10 are provided in the information processing apparatus 30 is also possible. For example, the terminal apparatus 10 may have some or all of the components of the information processing apparatus 30, and the information processing apparatus 30 may have some or all of the components of the terminal apparatus 10. For example, the information processing apparatus 30 according to the above embodiment may be used to provide Mobility as a Service (MaaS), a service that leverages mobility.

For example, in the embodiment described above, the controller 35 may provide an interface that allows modification of the transit points included and the times to pass the transit points in the created operation schedule.

Specifically, for example, the controller 35 provides a button for modifying the information of the operation schedule on the screen displaying the information of the operation schedule created in S101. When the user presses the button, the controller 35 displays a form for modifying the information contained in the operation schedule on the screen of the terminal apparatus 10 or the information processing apparatus 30. When the user modifies information included in the operation schedule, such as transit points, times to pass the transit points, and vehicles, on the screen, the controller 35 reflects the modification in the information on the operation schedule and redisplays the operation schedule on the screen displaying the information on the operation schedule. The operation schedule that can be modified by the interface is not limited to the operation schedule that has been created, but may include the operation schedules for other extra services and scheduled fixed route services.

For example, in the embodiment described above, the controller 35 may output the information on the created operation schedule to a GTFS file.

Specifically, for example, the controller 35 provides a button on the screen displaying the information on the operation schedule created in S101 to output the information on the operation schedule to a GTFS file. When the user presses the button, the controller 35 outputs the information on the operation schedule to the GTFS file. The controller 35 may provide a form for specifying the position for the output in the memory 14 or the memory 34, such as an output folder designation, for example, or output to a predetermined position in the memory 14 or the memory 34. Thus, by outputting the information on the created operation schedule to the GTFS file, the user's work can be made more efficient when operating a new extra service.

For example, in the embodiment described above, the controller 35 may output information on the operation schedules for all operating services to a single GTFS file.

Specifically, for example, the controller 35 provides a button on the screen of the terminal apparatus 10 or the information processing apparatus 30 on which information on multiple operation schedules, including the operation schedules created in S101, is displayed, to output the information on the multiple operation schedules into a single GTFS file. When the user presses the button, the controller 35 outputs the information on the multiple operation schedules to a single GTFS file. The controller 35 may provide a form for specifying the position for the output in the memory 14 or the memory 34, such as an output folder designation, for example, or output to a predetermined position in the memory 14 or the memory 34.

The information on multiple operation schedules to be output to a single GTFS file is not limited to those displayed on the screen of the terminal apparatus 10 or the information processing apparatus 30, but may be all those that satisfy the specified conditions. The controller 35 may also output information on multiple operation schedules to multiple GTFS files. Thus, by outputting the operation schedule information to a GTFS file, the user can modify the operation schedule on an apparatus other than the terminal apparatus 10 or the information processing apparatus 30, for example.

The “specified conditions” may be any conditions related to the operation schedule, such as a schedule selected by the user, a schedule to be managed by the user, or a schedule at a time specified by the user, or the like.

For example, in the embodiment described above, the controller 35 may provide an interface to modify a scheduled fixed route service to an extra service and an extra service to a scheduled fixed route service.

Specifically, for example, the controller 35 provides a button on the screen displaying information on multiple operation schedules, including the operation schedule created in S101, that allows the user to specify and modify any of the multiple operation schedules, from a scheduled fixed route service to an extra service, or from an extra service to a scheduled fixed route service.

For example, in the embodiment described above, if the vehicle 20 includes an automated driving vehicle, the information on the vehicle 20 may include information on the automated driving control apparatus (hereinafter also referred to as “automated driving development kit” or “ADK”) that the vehicle 20 is equipped with.

In this case, the information on the operating service may include information on one or more corresponding pieces of ADK information.

“ADK information” may include, for example, Level 1 to 5 as defined by the Society of Automotive Engineers (SAE), or the setting of an operational category, such as manual driving.

If corresponding ADK information is included in the “information on the operating service”, the controller 35 may also acquire the ADK information among the information on the operating service or the operation schedule selected in S100 as the information on the extra service. In this case, the controller 35 may perform control in S101 so that a vehicle 20 can be assigned to an extra service only if any ADK information included in the information on the extra service matches the ADK information included in the information on the vehicle 20.

For example, in the variation described above, the one or more corresponding pieces of ADK information may be included in each piece of information on the transit points included in the information on the operating service. In this case, the controller 35 may perform control in S101, for all of the information on the transit points included in the information on the extra service, so that the vehicle 20 can be assigned to the extra service only if any ADK information included in each piece of information on the transit points matches the ADK information included in the information on the vehicle 20.

For example, in the embodiment described above, the controller 35 may display information on the screen of the terminal apparatus 10 or the information processing apparatus 30 in a manner that makes it possible to distinguish between information on the operation schedule for the scheduled fixed route service and information on the operation schedule for the extra service.

For example, “a manner that makes it possible to distinguish” can be in any manner, such as using a different color only for the extra service, or displaying an extra service sign on the extra service.

For example, an embodiment in which a general purpose computer functions as the terminal apparatus 10 or the information processing apparatus 30 according to the above embodiment can also be implemented. Specifically, a program in which processes for realizing the functions of the terminal apparatus 10 or the functions of the information processing apparatus 30 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by an information processing apparatus used for providing an operation management system that manages operations of a plurality of vehicles, the method comprising:
acquiring information on an extra service based on a GTFS file containing information on the extra service to be additionally registered in the operation management system or based on information on an operating service that has been registered in the operation management system; and
creating an operation schedule for the extra service based on the information on the extra service.

2. The method according to claim 1, wherein the information processing apparatus selects a vehicle to be assigned to the extra service from among the plurality of vehicles excluding each vehicle that has already been assigned to any of operating services registered in the operation management system, and creates the operation schedule for the extra service by assigning the selected vehicle to the extra service.

3. The method according to claim 1, further comprising providing an interface that allows modification of a transit point and a time to pass the transit point included in the created operation schedule.

4. The method according to claim 1, further comprising outputting information on the created operation schedule to a GTFS file.

5. The method according to claim 1, wherein the information processing apparatus changes a service ID included in the information on the operating service that has been registered and acquires the information on the extra service.

6. A method, by a processor, for improving travel mobility as a service (MaaS), comprising processing steps executed by the information processing apparatus according to claim 1.
